(19) United States
(12) Patent Application Publication
(10) Pub. No.: US 2008/0296377 A1
(43) Pub. Date: Dec. 4, 2008

(54) Tamper-proof card reader

(76) Inventors: Juergen Hopt, Rottweil (DE); Michael Storz, Bad Duerrheim (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/150,028

(22) Filed: Apr. 24, 2008

(30) Foreign Application Priority Data
Jun. 1, 2007 (EP) 07 010 877.4-2210

(51) Int. Cl. G06K 7/06

(52) U.S. Cl. 235/441

(57) ABSTRACT

In accordance with the invention, a card reader (1) comprising a contacting unit (2) for a card (4) that can be inserted through a card insertion opening (6), comprises on its mounting side (7) a conductor path element (8) that can be bent against the action of an elastic restoring force and comprises two exposed electrical contacts (9a, 9b), and the bendable conductor path element (8) can be bent between its two exposed contacts (9a, 9b) until the two exposed contacts (9a, 9b) abut each other against the action of the elastic restoring force in an electrically conducting fashion.

The present invention relates to a card reader, in particular a chip card reader, comprising a contacting unit for a card that has been inserted through a card insertion opening.

With conventional card readers of this type, it is possible to manipulate the data exchange with a card by unsoldering the card reader that is soldered to a customer's printed circuit board, lifting it off the customer's printed circuit board, and contacting the electrical contacts of the contacting unit that are then accessible.

It is the object of the present invention to protect a card reader of the above-mentioned type against such lifting, i.e. to provide a “safe card reader”.

This object is achieved in accordance with the invention in that a conductor path element that can be bent against the action of an elastic restoring force and comprises two exposed electrical contacts is provided on a mounting side of the card reader, and the bendable conductor path element can be bent between its two exposed contacts until the two exposed contacts abut each other against the action of the elastic restoring force in an electrically conducting fashion.

When the card reader is in a state ready for mounting, the bendable conductor path element is bent between its two exposed contacts by more than 90°, but less than 180°, thereby spacing apart the two exposed contacts. When the card reader is disposed onto the customer's printed circuit board, the bendable conductor path element is bent further between the card reader and the customer's printed circuit board until the two exposed contacts abut each other in an electrically conducting fashion, thereby closing the switch formed by the two exposed contacts. When the card reader is unsoldered or even removed from the customer's printed circuit board with the intention of manipulation, the two exposed contacts are lifted off each other already on the slightest lifting motion of the card reader due to the elastic restoring force, and the switch opens. A control unit of the customer's printed circuit board will detect this and subsequently prevent any reading process or render the contacting unit inoperative. Unnoticed manipulation of the contacting unit is therefore not possible and a “tamper-proof” card reader is obtained.

The contacting unit is preferably surrounded by a drill-protection pocket which is open at the card insertion opening and has a fine-meshed conductor path structure with at least one continuous conductor path and a recess provided on the mounting side of the card reader, within which the bendable conductor path element is provided. The pocket is preferentially formed by at least one conductor path foil which also comprises the bendable conductor path element. When the pocket is removed or destroyed, e.g. by drilling, the at least one continuous conductor path, through which a current flows during operation, is cut through. This is also detected by the control unit of the customer's printed circuit board, which then prevents any further reading process or disables the contacting unit.

The invention also relates to a one-piece conductor path foil blank for such a card reader pocket, wherein the conductor path foil blank comprises a fine-meshed conductor path structure, which forms the at least one continuous conductor path in the erected state of the pocket, and also the above described bendable conductor path element.

Further advantages of the invention can be extracted from the description, the claims, and the drawing. The features mentioned above and below may be used individually or collectively in arbitrary combination. The embodiments shown and described are not to be understood as exhaustive enumeration but have exemplary character for describing the invention.

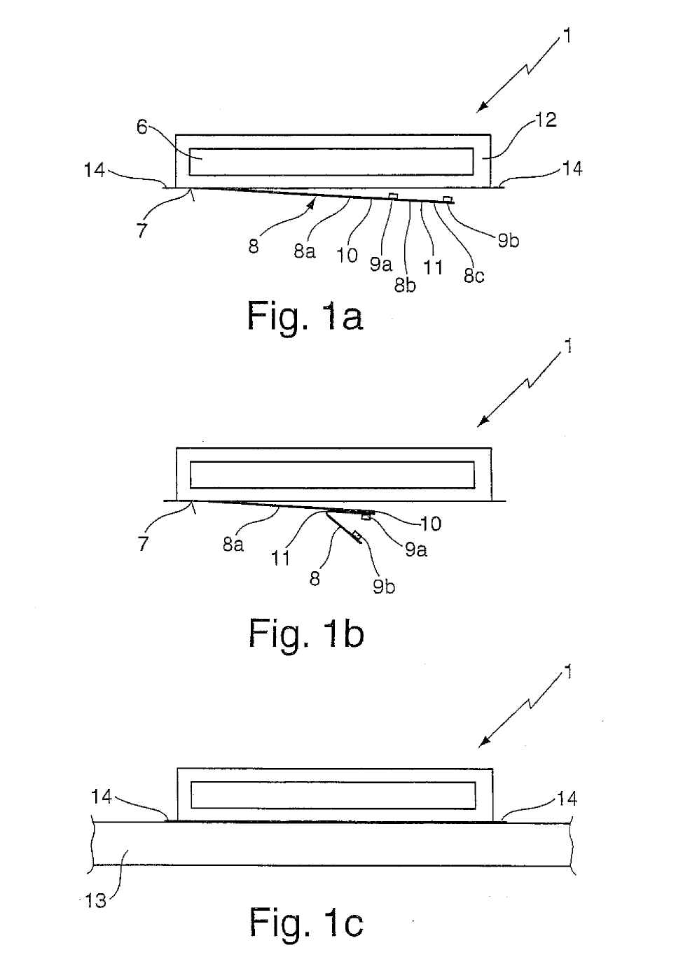

FIG. 1 shows a schematic side view of the inventive card reader with a conductor path element which has not yet been bent (FIG. 1a), with the conductor path element in a state ready for mounting (FIG. 1b), and with the conductor path element in the mounted state on a customer's printed circuit board (FIG. 1c);

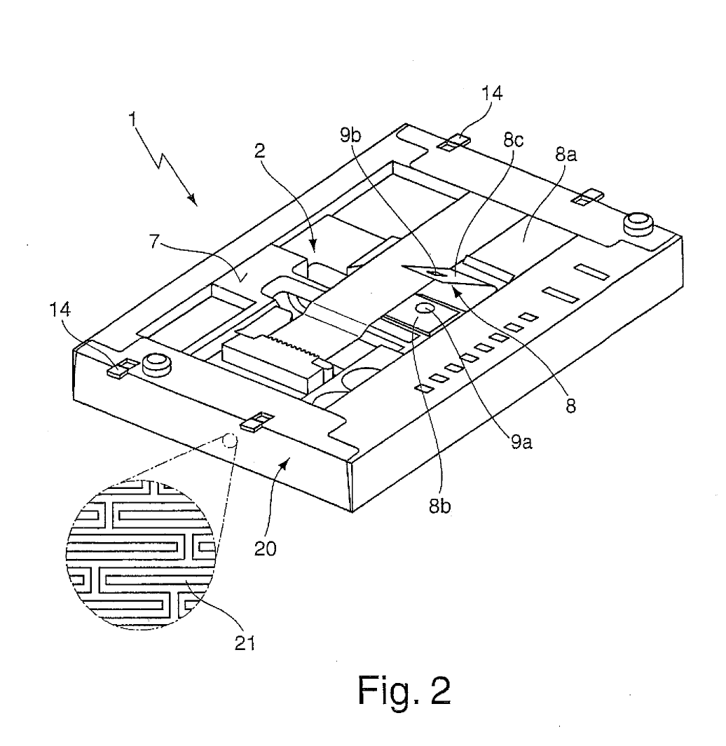

FIG. 2 shows a perspective top view of a lower side of the card reader of FIG. 1b in a state ready for mounting, and of its rear side facing away from the card insertion opening;

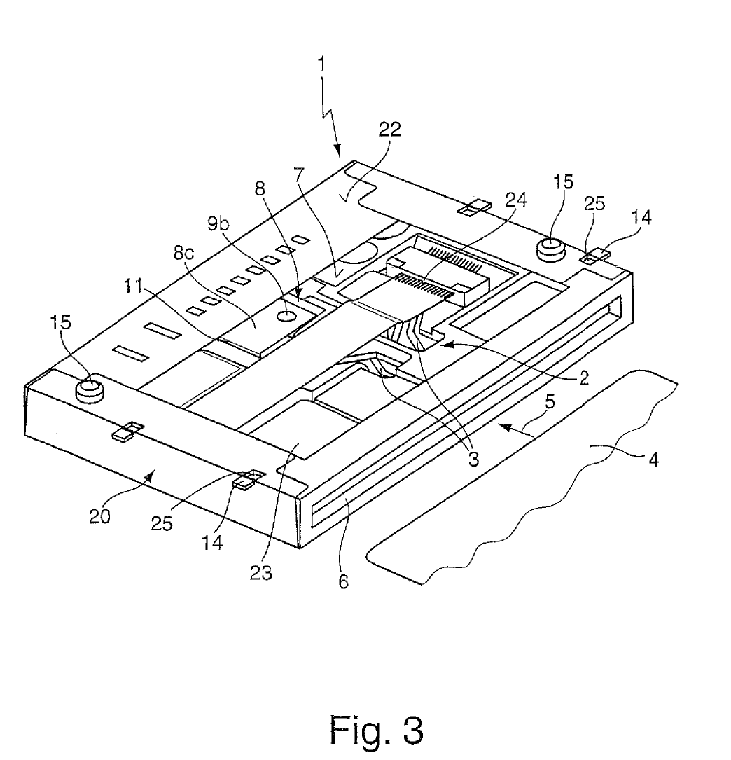

FIG. 3 shows a perspective top view of a lower side of the card reader of FIG. 1c in the mounted state, and of its card insertion opening, however, without the customer's printed circuit board; and

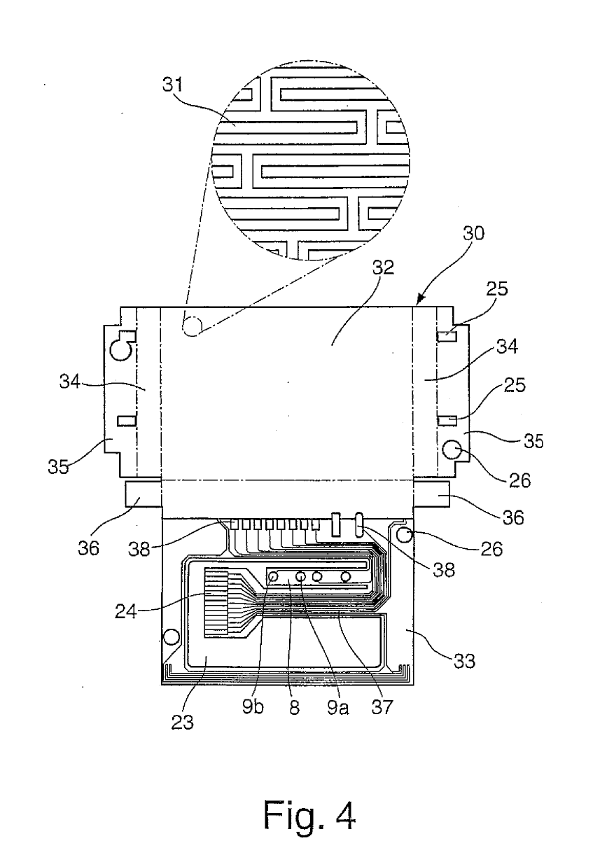

FIG. 4 shows a conductor path foil blank from which a drill-protection pocket, as shown in FIGS. 2 and 3, is folded.

The chip card reader 1, which is shown in FIGS. 1 through 3, has a contacting unit 2 with electrical contact springs 3 in order to contact electric contact fields (not shown) of a chip card 4 that has been inserted into the contacting unit 2. The chip card 4 has a microchip (not shown) for storing data, whose contacts are provided as electric contact fields on the card surface. The user inserts the chip card 4 in the insertion direction 5 via a card insertion opening 6 into the contacting unit 2 up to the data exchange position and removes it again from the contacting unit 2 after data exchange (so-called push/pull card reader).

In order to protect the contacting unit 2 against manipulation, the card reader 1 has a conductor path element 8 on its bottom or mounting side 7, which can be bent against the action of an elastic restoring force, with two exposed electrical contacts (e.g. gold contacts) 9a, 9b. The conductor path element 8 is formed by a unilaterally mounted, single-layered conductor path strip whose conductor paths as well as the exposed contacts 9a, 9b are provided on the strip side facing the mounting side 7. The bendable conductor path element 8 is divided by two folding lines 10, 11 into three sections, namely into a first section 8a mounted to the card reader housing 12, a second section 8b that joins the first section 8a and comprises one exposed contact 9a, and a third section 8c that joins the second section 8b and comprises the other exposed contact 9b. In the initial state of the card reader 1 as shown in FIG. 1a, the conductor path element 8 is straight, i.e. not yet bent.

In the state of the card reader 1 ready for mounting as shown in FIG. 1b, the second section 8b is bent about the folding line 10 in abutment with the first section 8a, and glued thereto. The first section 8a may be glued to the mounting side 7. The third section 8c is bent about the folding line 11 in the direction towards the second section 8b until it forms an acute angle of e.g. 45° with respect to the second section 8c, and the two exposed contacts 9a, 9b are opposite to each other but still spaced apart.

The card reader 1 is then disposed with its mounting side 7 onto a customer's printed circuit board 13 and fixedly soldered onto the customer's printed circuit board 13 by means of four lateral contact legs 14 (FIG. 1c). Between the card reader 1 and the customer's printed circuit board 13, the third section 8c is thereby bent further towards the second section 8b against the action of the elastic restoring force, until the two exposed contacts 9a, 9b finally abut each other in an electrically conducting fashion, thereby closing the switch formed by the two exposed contacts 9a, 9b. When the card reader 1 is unsoldered or even removed from the customer's printed circuit board 13 with the intention of manipulation, the two exposed contacts 9a, 9b are lifted off each other already on the slightest lifting motion of the card reader 1 due to the elastic restoring force, and the switch opens. A control unit (not shown) of the customer's printed circuit board 13 will detect this and subsequently stop any reading process or render the contacting unit 2 inoperative. Unnoticed manipulation of the contacting unit 2 is thus not possible, so that a “tamper-proof” card reader 1 is provided.

The contacting unit 2 is surrounded by a drill-protection pocket 20 (FIGS. 2 and 3) which is open at the card insertion opening 6 and is folded from one single conductor path foil blank 30 (FIG. 4) which also comprises the bendable conductor path element 8.

The pocket 20 has a fine-meshed (e.g. meandering) conductor path structure covering its entire surface area, with e.g. two continuous conductor paths 21 and a recess 23 provided on the pocket lower side 22, within which the connecting contacts 24 of the card reader 1 and the bendable conductor path element 8 are provided. The card reader 1 is mounted to the customer's printed circuit board 13 by means of the four contact legs 14 of the contacting unit 2, which project through corresponding holes 25 of the pocket 20 and are fixedly soldered to the customer's printed circuit board 13 using SMD technology. The contacting unit 2 has two pins 15 on the bottom side at two diagonally opposite locations, which pass through corresponding holes 26 (FIG. 4) of the pocket 20, thereby positioning the pocket 20 on the contacting unit 2.

As is shown in FIG. 4, the conductor path foil blank 30 comprises a conductor path structure covering its entire surface area, with several open conductor path traces 31 which extend at a minimum distance from each other and form the continuous conductor paths 22 in the erected state of the pocket 20, and also the bendable conductor path element 8. The conductor path foil blank 30 has a top section 32 that forms the upper side of the pocket, a bottom section 33 that forms the lower side of the pocket, including the recess 23, three side wall sections 34 with two lateral overlapping sections 35 and two tab sections 36, wherein these sections can be bent at the folding lines indicated by dash-dotted lines due to their flexibility. When the pocket 20 is formed, the open conductor path traces 31 of the individual sections 32 to 36 are electrically connected to each other to form the two continuous conductor paths 21. Within its recess 23, the bottom section 33 comprises the bendable conductor path element 8 which is formed as a conductor path strip, and a further conductor path strip 37 the free flexible end of which bears the connecting contacts 24. Ten soldering surfaces (soldering pads) 38 are provided in the bottom section 33 for a solder connection with the eight contact springs of the contacting unit 2 and an end switch (not shown). These ten soldering surfaces 38 and the four ends of the two continuous conductor paths 22 are connected to the connecting contacts 24 via the conductor paths of the conductor path strip 37. The two exposed contacts 9a, 9b of the bendable conductor path element 8 are provided in one of the two continuous conductor paths 22, such that this conductor path is interrupted when the contacts 9a, 9b are lifted apart. The conductor path foil blank 30 moreover has holes 25 for the contact legs 14 and holes 26 for the pins 15 of the contacting unit 2.

The card reader 1 is connected at its connecting contacts 24 to a corresponding plug (e.g. molex plug) of the customer's printed circuit board 13 and then mounted to the customer's printed circuit board 13 by means of the contact legs 14. When the pocket 20 is removed or destroyed, e.g. by drilling, or when the contacting unit 2 is lifted off the customer's printed circuit board 13, one or both continuous conductor paths 21, through which a current flows during operation, are cut through. The control unit of the customer's printed circuit board 13 will detect this and then prevent any reading process or render the contacting unit 2 inoperative.

1. Card reader (1) comprising a contacting unit (2) for a card (4) that can be inserted through a card insertion opening (6),
characterized in that a conductor path element (8) that can be bent against the action of an elastic restoring force and comprises two exposed electrical contacts (9a, 9b) is provided on a mounting side (7) of the card reader (1), and
that the bendable conductor path element (8) can be bent between its two exposed contacts (9a, 9b) until the two exposed contacts (9a, 9b) abut each other against the action of an elastic restoring force in the electrically conducting fashion.

2. Card reader according to claim 1, characterized in that the bendable conductor path element (8) comprises a folding line (11) at least between its two exposed contacts (9a, 9b).

3. Card reader according to claim 1 or 2, characterized in that in a state of the card reader (1) ready for mounting, the bendable conductor path element (8) is bent between its two exposed contacts (9a, 9b) by more than 90° and the two exposed contacts (9a, 9b) are spaced apart from each other.

4. Card reader according to any one of the preceding claims, characterized in that the bendable conductor path element (8) is formed by a unilaterally mounted conductor path strip.

5. Card reader according to any one of the preceding claims, characterized in that the bendable conductor path element (8) has a one-layer design with the conductor paths being provided on only one side, or a two-layer design with the conductor paths being provided on both sides.

6. Card reader according to any one of the preceding claims, characterized in that the bendable conductor path element (8) comprises a unilaterally mounted first section (8a), a second section (8b) that joins the first section (8a) and comprises one exposed contact (9a), and a third section (8c) that joins the second section (8b) and comprises the other exposed contact (9a), wherein the two exposed contacts (9a, 9b) are provided on the side of the bendable conductor path element (8) facing the mounting side (7), and the three sections (8a-8c) can be bent or are bent in a Z-shape.

7. Card reader according to any one of the preceding claims, characterized in that the contacting unit (2) is surrounded by a drill-protection pocket (20) which is open at the card insertion opening (6) and comprises a fine-meshed conductor path structure with at least one continuous conductor path (22), as well as the bendable conductor path element (8).

8. Card reader according to claim 7, characterized in that the pocket (20) has a recess (23) on the lower side (22) of the pocket that forms the bottom of the card reader (1), within which the bendable conductor path element (8) is provided.

9. Card reader according to claim 7 or 8, characterized in that the pocket (20) is formed from at least one conductor path foil (30) which also comprises the bendable conductor path element (8).

10. One-piece conductor path foil blank (30) for a drill-protection pocket (20) of the card reader (1) according to any one of the claims 7 through 9, wherein the conductor path foil blank (30) comprises a fine-meshed conductor path structure which forms the at least one continuous conductor path (22) in the erected state of the pocket (20), as well as the bendable conductor path element (8).
